(19) United States
(12) Patent Application Publication
(10) Pub. No.: US 2024/0073877 A1
(43) Pub. Date: Feb. 29, 2024

(54) BATCH NUMBERING OF ONE OR MORE CONFIGURATION COMMANDS FOR A RADIO UNIT (RU)

(71) Applicant: QUALCOMM Incorporated, San Diego, CA (US)

(72) Inventors: Michael Francis Garyantes, Bradley Beach, NJ (US); Abhishek Saurabh Sachidanand Sinha, San Diego, CA (US); Kalyan Kuppuswamy, San Diego, CA (US)

(21) Appl. No.: 18/356,130

(22) Filed: Jul. 20, 2023

Related U.S. Application Data
(60) Provisional application No. 63/373,544, filed on Aug. 25, 2022.

(51) Int. Cl. H04W 72/0453; H04W 24/02

(52) U.S. Cl. CPC H04W 72/0453; H04W 24/02

(57) ABSTRACT

An apparatus for wireless communication by a network entity includes a memory and one or more processors coupled to the memory. The one or more processors are configured to receive one or more configuration commands associated with a carrier having a first configuration. The one or more configuration commands each indicate a batch number. The one or more processors are further configured to store the one or more configuration commands and, based on detection of a trigger event, to perform a reconfiguration of the carrier from the first configuration to a second configuration that is based on the one or more configuration commands.

### CROSS-REFERENCE TO RELATED APPLICATIONS

This application claims the benefit of U.S. Prov. Pat. App. No. 63/373,544, entitled “BATCH NUMBERING OF ONE OR MORE CONFIGURATION COMMANDS FOR A RADIO UNIT (RU)” and filed on Aug. 25, 2022, which is expressly incorporated by reference herein in its entirety.

### TECHNICAL FIELD

Aspects of the present disclosure relate generally to wireless communication systems, and more particularly, to configuration commands for a radio unit (RU) of a wireless communication system.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

To enhance user experience and address the growing demand for mobile broadband access, some wireless communication systems may dynamically change configurations associated with wireless communications. For example, a base station may change the configuration of a carrier used to communicate with a UE, such as by increasing or decreasing a transmit power associated with the carrier to compensate for interference or to reduce power consumption. In some cases, changing a configuration of a carrier may be associated with unpredictable or undesirable operation, such as if multiple different changes to the carrier are performed (which may result in an unpredictable or unknown “intermediate” state of the carrier, and which may lead to poor performance).

To reduce or prevent such unpredictable states, some wireless communication systems may disable the carrier prior to performing changes to the carrier and may reenable the carrier after the changes to the carrier are completed. Such a technique may reduce availability of wireless communication resources, increasing latency or otherwise reducing performance. Some other wireless communication systems may temporarily reassign the carrier to another base station. Such a technique may use resources (such as processing resources and wireless resources) to schedule and implement the reassignment and may also increase loading associated with the other base station.

### BRIEF SUMMARY OF SOME EXAMPLES

In some aspects of the disclosure, an apparatus for wireless communication by a network entity includes a memory and one or more processors coupled to the memory. The one or more processors are configured to receive one or more configuration commands associated with a carrier having a first configuration. The one or more configuration commands each indicate a batch number. The one or more processors are further configured to store the one or more configuration commands and, based on detection of a trigger event, to perform a reconfiguration of the carrier from the first configuration to a second configuration that is based on the one or more configuration commands.

In some other aspects of the disclosure, a method of wireless communication performed by a network entity includes receiving one or more configuration commands associated with a carrier having a first configuration. The one or more configuration commands each indicate a batch number. The method further includes storing the one or more configuration commands and further includes, based on detecting a trigger event, performing a reconfiguration of the carrier from the first configuration to a second configuration that is based on the one or more configuration commands.

In some other aspects, an apparatus for wireless communication by a network entity includes a memory and one or more processors coupled to the memory. The one or more processors are configured to transmit one or more configuration commands associated with a carrier. The one or more configuration commands each indicate a batch number. The one or more processors are further configured to receive a reporting message indicating a status associated with reconfiguration of the carrier from a first configuration to a second configuration based on the one or more configuration commands.

In some other aspects of the disclosure, a method of wireless communication by a network entity includes transmitting one or more configuration commands associated with a carrier. The one or more configuration commands each indicate a batch number. The method further includes receiving a reporting message indicating a status associated with reconfiguration of the carrier from a first configuration to a second configuration based on the one or more configuration commands.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating details of an example wireless communication system that supports batch numbering of one or more configuration commands for a radio unit (RU) according to one or more aspects.

FIG. 2 is a block diagram illustrating examples of a base station and a user equipment (UE) that support batch numbering of one or more configuration commands for an RU according to one or more aspects.

FIG. 3 is a block diagram illustrating an example disaggregated base station architecture that supports batch numbering of one or more configuration commands for an RU according to one or more aspects.

FIG. 4 is a block diagram illustrating an example wireless communication system that supports batch numbering of one or more configuration commands for an RU according to one or more aspects.

FIG. 5 is a flow diagram illustrating an example method that supports batch numbering of one or more configuration commands for an RU according to one or more aspects.

FIG. 6 is a flow diagram illustrating another example method that supports batch numbering of one or more configuration commands for an RU according to one or more aspects.

Like reference numbers and designations in the various drawings indicate like elements.

### DETAILED DESCRIPTION

In some aspects of the disclosure, batch numbers may be assigned to configuration commands of a carrier to enable batch reconfiguration operations. For example, a distributed unit (DU) of an open radio access network (O-RAN) may provide a configuration command to a radio unit (RU) of the O-RAN, and the configuration command may indicate a batch number. The RU may store (e.g., cache or buffer) one or more such configuration commands associated with the batch number until receiving an instruction from the DU indicating a trigger event. For example, the instruction may indicate a particular frame or sub-frame at which time the RU is to perform an update of the carrier based on each configuration command associated with the batch number. Upon detecting the trigger event, the RU may perform a reconfiguration of the carrier based on one or more stored configuration commands associated with the batch number.

By using the batch number, the RU may implement multiple configuration commands at a common time or within a common time interval. As a result, the RU may avoid or reduce instances of an unknown or intermediate configuration of the carrier (which may occur if the multiple configuration commands arrive at or are executed by the RU out-of-order). Further, in some examples, the RU may perform reconfiguration of the carrier on-the-fly and without temporarily disabling the carrier during the reconfiguration. The RU may also perform the reconfiguration of the carrier without reassigning the carrier to another RU during the reconfiguration. As a result, availability of wireless resources is increased while also reducing or avoiding overhead associated with scheduling reassignment of the carrier, enhancing performance of a wireless communication system.

In some aspects, the reconfiguration may be coordinated among multiple RUs to improve performance or to avoid a conflict between the multiple RUs. To illustrate, in an example, a first RU may be deactivated (e.g., based on a time of day, based on a quantity of UEs connected to the first RU failing to exceed a threshold, or based on one or more other criteria), and a transmit power associated with a second RU may be increased via the reconfiguration while the first RU is in a deactivated state. In such examples, the transmit power may be increased while the second RU is less susceptible to interference (e.g., while in the deactivated state). Other examples are further described with reference to the drawings.

In various implementations, one or more aspects described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RAT s) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology.

Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., −0.99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

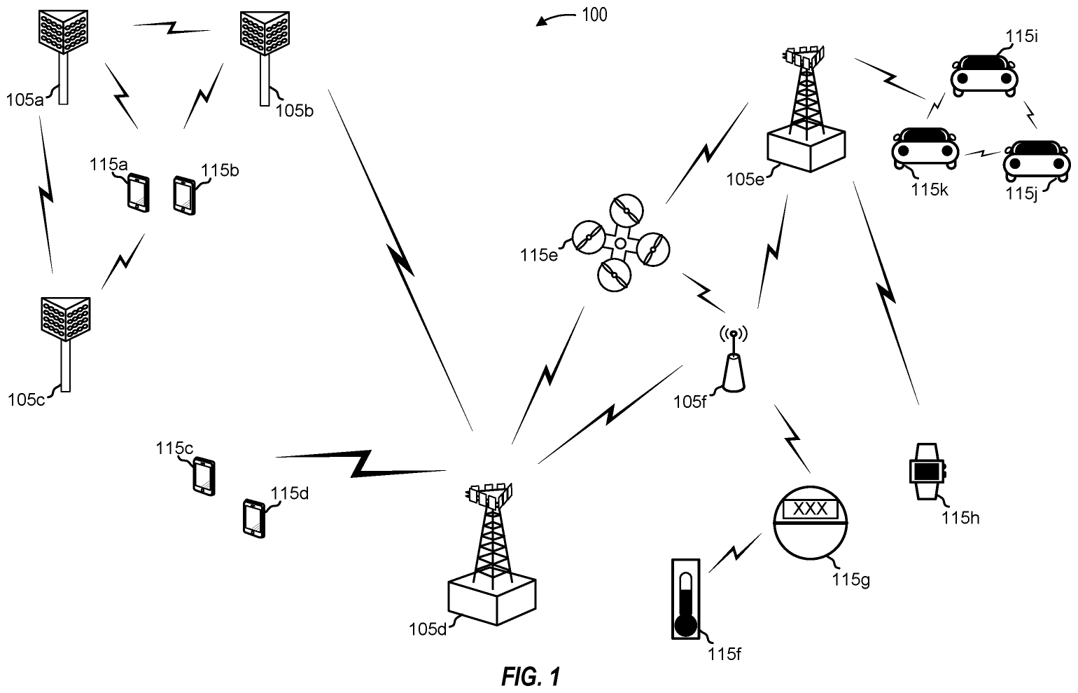

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such as UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

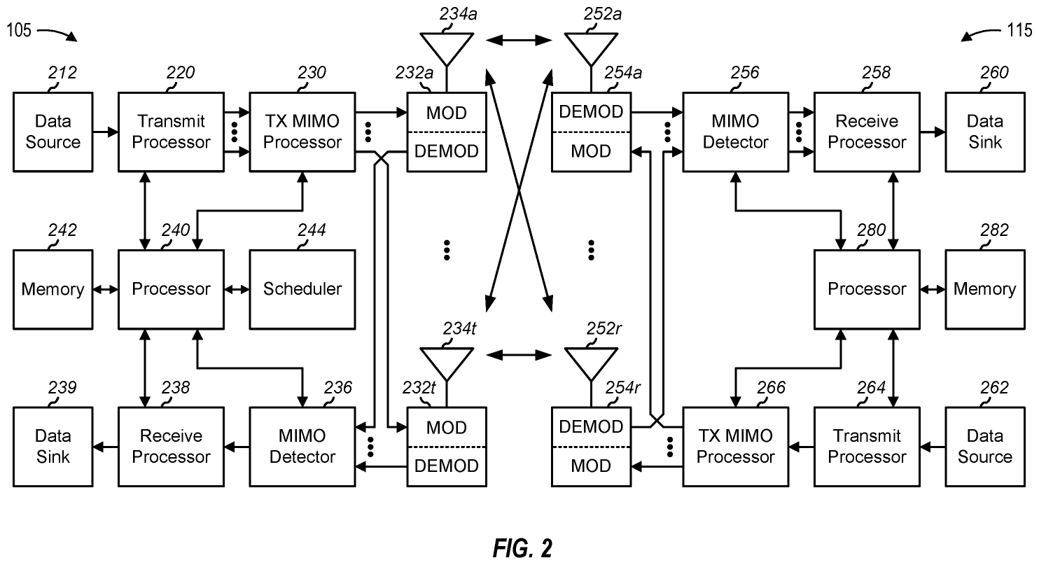

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from processor 240. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to processor 280.

On the uplink, at UE 115, transmit processor 264 may receive and process data (e.g., for a physical uplink shared channel (PUSCH)) from data source 262 and control information (e.g., for a physical uplink control channel (PUCCH)) from processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to processor 240.

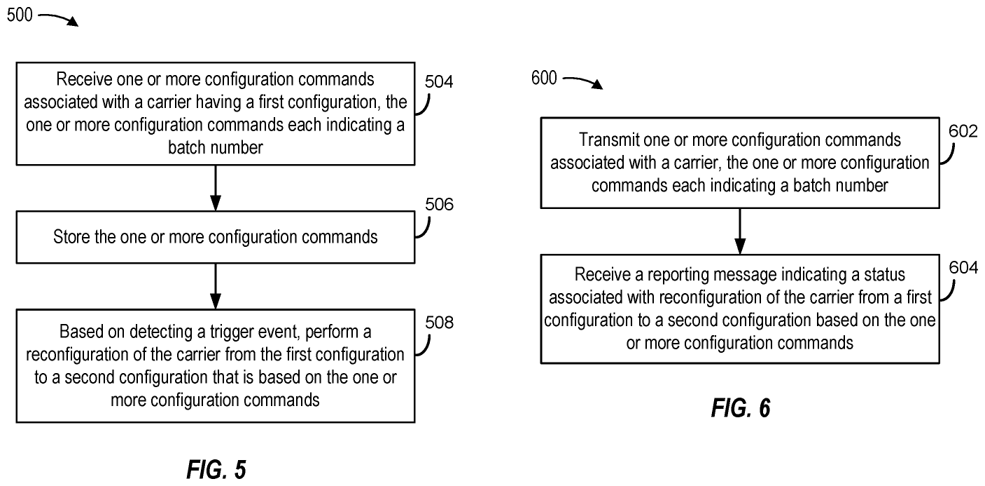

Processors 240 and 280 may direct the operation at base station 105 and UE 115, respectively. Processor 240 or other processors and modules at base station 105 or processor 280 or other processors and modules at UE 115 may perform or direct the execution of various processes for the techniques described herein, such as to perform or direct the execution illustrated in FIGS. 5 and 6 or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

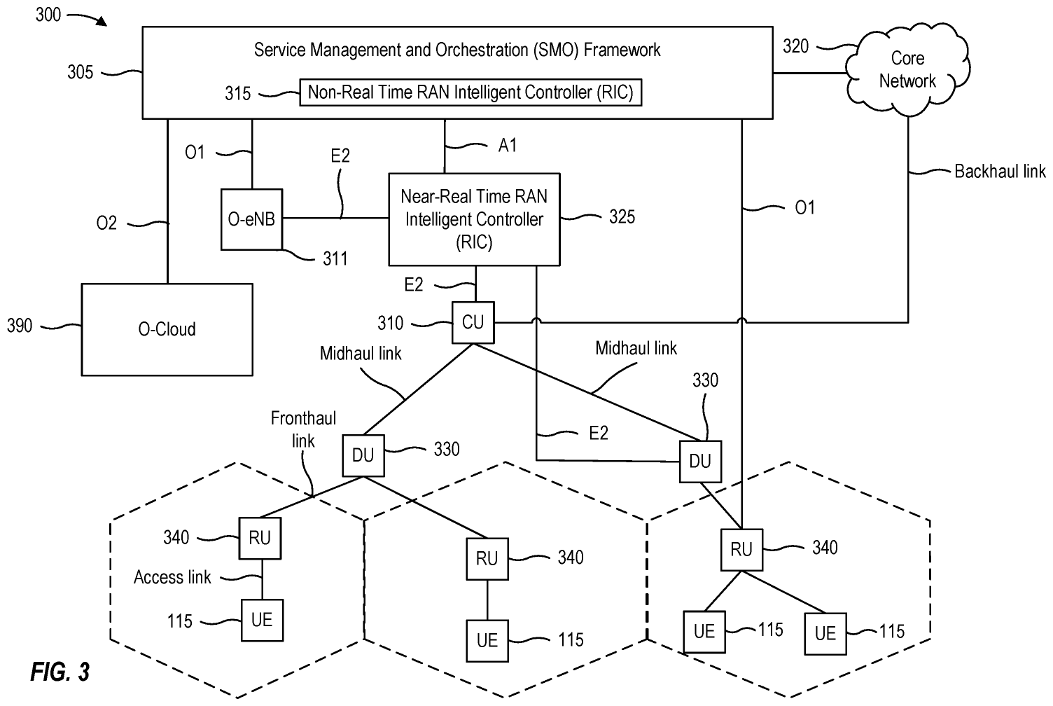

FIG. 3 shows a diagram illustrating an example disaggregated base station 300 architecture. In some examples, the disaggregated base station 300 architecture may be used to implement the base station 105. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links.

In some implementations, the UE 115 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (which may be referred to as Central Unit—User Plane (CU-UP) functionality), control plane functionality (which may be referred to as Central Unit—Control Plane (CU-CP) functionality), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT) operations, inverse FFT (iFFT) operations, digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as AI policies).

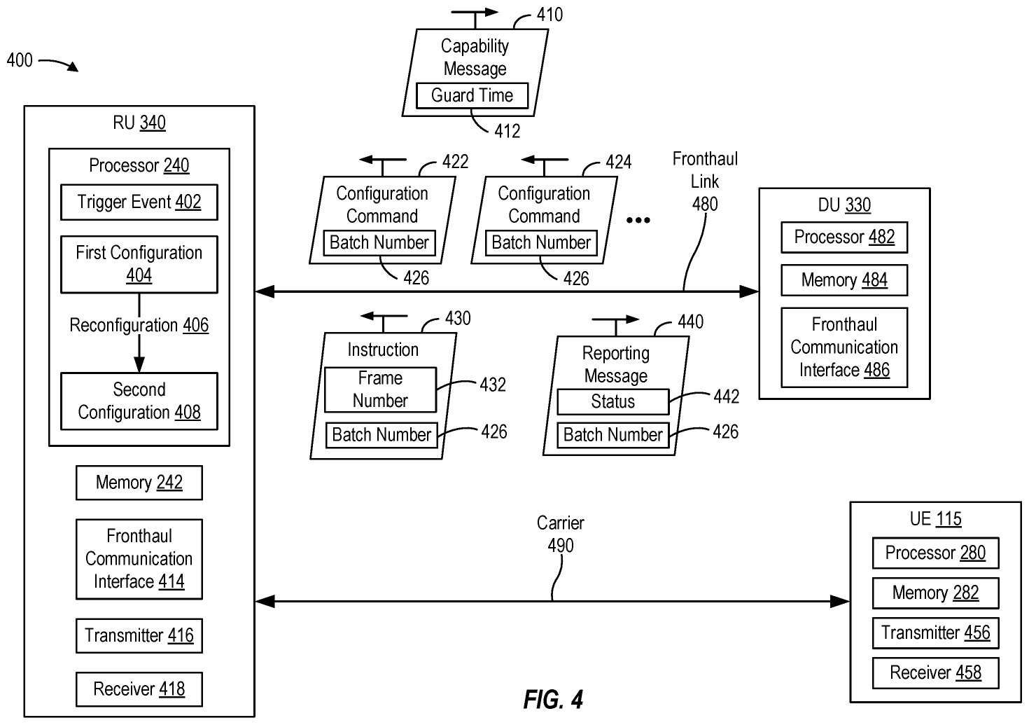

FIG. 4 is a block diagram illustrating an example of a wireless communication system 400 that supports batch numbering of one or more configuration commands for an RU according to some aspects of the disclosure. The wireless communication system 400 may include the DU 330 and the RU 340, which may implement at least a portion of the base station 105. The wireless communication system 400 may include one or more UEs, such as the UE 115.

The RU 340 may include one or more processors (such as the processor 240), one or more memories (such as the memory 242), a fronthaul communication interface 414, a transmitter 416, and a receiver 418. The processor 240 may be coupled to the memory 242, to the fronthaul communication interface 414, to the transmitter 416, and to the receiver 418. In some examples, any of the fronthaul communication interface 414, the transmitter 416, and the receiver 418 may include one or more components described with reference to FIG. 2, such as one or more of the modulator/demodulators 232a-t, the MIMO detector 236, the receive processor 238, the transmit processor 220, or the TX MIMO processor 230. In some implementations, the transmitter 416 and the receiver 418 may be integrated in one or more transceivers of the RU 340.

The fronthaul communication interface 414 may be configured to communicate with the DU 330 via a fronthaul link 480. For example, the RU 340 may transmit and receive control information and other data used by the RU 340 to communicate with the UE 115.

The transmitter 416 may be configured to transmit reference signals, synchronization signals, control information, and data to one or more other devices, and the receiver 418 may be configured to receive reference signals, control information, and data from one or more other devices. For example, the transmitter 416 may be configured to transmit signaling, control information, and data to the UE 115, and the receiver 418 may be configured to receive signaling, control information, and data from the UE 115. In some examples, one or both of the transmitter 416 or the receiver 418 may communicate with the UE 115 via a carrier 490. The carrier 490 may be included in or may be associated with the access link described with reference to FIG. 3.

The UE 115 may include one or more processors (such as the processor 280), a memory (such as the memory 282), a transmitter 456, and a receiver 458. The processor 280 may be coupled to the memory 282, to the transmitter 456, and to the receiver 458. In some examples, the transmitter 456 and the receiver 458 may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 456 and the receiver 458 may be integrated in one or more transceivers of the UE 115.

The transmitter 456 may transmit reference signals, synchronization signals, control information, and data to one or more other devices, and the receiver 458 may receive reference signals, control information, and data from one or more other devices. For example, in some implementations, the transmitter 456 may transmit signaling, control information, and data to the RU 340, and the receiver 458 may receive signaling, control information, and data from the RU 340. In some examples, one or both of the transmitter 456 or the receiver 458 may communicate with the RU 340 via carrier 490.

The DU 330 may include one or more processors (such as a processor 482), one or more memories (such as a memory 484), and a fronthaul communication interface 486. The processor 240 may be coupled to the memory 242 and to the fronthaul communication interface 486. The fronthaul communication interface 486 may be configured to communicate with the RU 340 via the fronthaul link 480. For example, the DU 330 may transmit and receive control information and other data used by the RU 340 to communicate with the UE 115.

The wireless communication system 400 may use wireless communication channels, which may be specified by one or more wireless communication protocols, such as a 5G NR wireless communication protocol. To illustrate, the RU 340 may communicate with the UE 115 using one or more downlink wireless communication channels (e.g., using one or more of a PDSCH or a PDCCH). The UE 115 may communicate with the RU 340 using one or more uplink wireless communication channels (e.g., using one or more of a PUSCH or a PUCCH). Depending on the example, the carrier 490 may be included in or may be associated with the PDSCH, the PDCCH, the PUSCH, the PUCCH, one or more other channels, or a combination thereof.

During operation, the RU 340 may communicate with the UE 115 using one or more carriers, such as the carrier 490. For example, the RU 340 may transmit signals (such as data, control information, or other signals) via the carrier 490. Alternatively or in addition the RU may receive signals (such as data, control information, or other signals) from the UE 115 via the carrier 490.

The carrier 490 may be associated with a first configuration 404. For example, the first configuration 404 may specify parameters associated with the carrier 490, such as one or more of a gain associated with the carrier 490, a transmit power (such as a transmit power of the RU 340 or a transmit power of the UE 115) associated with the carrier 490, a subcarrier spacing (SCS) associated with the carrier 490, a static physical random access channel (PRACH) configuration associated with the carrier 490, a static time division duplex (TDD) pattern associated with the carrier 490, a static sounding reference signal (SRS) configuration associated with the carrier 490, an endpoint configuration associated with the carrier 490 (such as a particular array carrier or a particular quantity of antenna elements), one or more other parameters associated with the carrier 490, or a combination thereof.

In some circumstances, the RU 340 may reconfigure the carrier 490 by changing one or more parameters associated with the carrier 490. For example, DU 330 may provide a configuration command 422 associated with the carrier 490 to the RU 340. The configuration command 422 may indicate a change to one or more parameters associated with the carrier 490. In some examples, the RU 340 may receive the configuration command 422 from the DU 330 via the fronthaul link 480 and using the fronthaul communication interface 414.

In some aspects of the disclosure, the configuration command 422 may indicate a batch number 426. The batch number 426 may be associated with a group of one or more configuration commands (including the configuration command 422) that are to be implemented together (e.g., as a single group) by the RU 340 (even if the one or more configuration commands are received separately over time by the RU 340).

To illustrate, upon receiving the configuration command 422, the RU 340 may store (e.g., cache or buffer) the configuration command 422 (e.g., instead of implementing the configuration command 422 upon receiving the configuration command 422). In some examples, the RU 340 may store the configuration command 422 to the memory 242. In some other examples, the RU 340 may store the configuration command 422 to another location, such as to a cache or buffer (e.g., a physical cache or buffer or a logical cache or buffer), which may be included in or accessible to the processor 240.

To further illustrate, in some examples, after receiving the configuration command 424, the RU 340 may receive a configuration command 424 associated with the carrier 490. The configuration command 424 may indicate the batch number 426. Upon receiving the configuration command 424, the RU 340 may store (e.g., cache) the configuration command 424 (e.g., instead of implementing the configuration command 424 upon receiving the configuration command 424). In some examples, the RU 340 may store the configuration command 424 to the memory 242. In some other examples, the RU 340 may store the configuration command 424 to another location, such as to a cache or buffer (e.g., a physical cache or buffer or a logical cache or buffer), which may be included in or coupled to the processor 240.

In some aspects, the RU 340 may store one or more configuration commands associated with the batch number 426 (such as the configuration commands 422 and 424) until detecting a trigger event 402. By storing the one or more configuration commands associated with the batch number 426, the RU 340 may defer reconfiguring the carrier 490 until detecting the trigger event 402. Based on detecting the trigger event 402, the RU 340 may implement one or more stored configuration commands associated with the batch number 426, such as the configuration commands 422 and 424.

The one or more configuration commands may be associated with a second configuration 408 of the carrier 490. For example, the one or more configuration commands may indicate one or more of a gain change associated with the carrier 490, a transmit power change (such as a change in transmit power of the RU 340 or a change in transmit power of the UE 115) associated with the carrier 490, an SCS change associated with the carrier 490, a static PRACH configuration change associated with the carrier 490, a static TDD pattern change associated with the carrier 490, a static SRS configuration change associated with the carrier 490, or an endpoint configuration change associated with the carrier 490 (such as a change from one array carrier to another array carrier or a change in a quantity of antenna elements).

As an illustrative example, the configuration command 422 may indicate one of the gain change, the transmit power change, the SCS change, the static PRACH configuration change, the static TDD pattern change, the static SRS configuration change, or the endpoint configuration change, and the configuration command 424 may indicate another of the gain change, the transmit power change, the SCS change, the static PRACH configuration change, the static TDD pattern change, the static SRS configuration change, or the endpoint configuration change. In such examples, the first configuration 404 may indicate one or more of a first gain associated with the carrier 490, a first transmit power associated with the carrier 490, a first SCS associated with the carrier 490, a first static PRACH configuration associated with the carrier 490, a first static TDD pattern associated with the carrier 490, a first static SRS configuration associated with the carrier 490, or a first endpoint configuration associated with the carrier 490, and the second configuration 408 may indicate one or more of a second gain associated with the carrier 490 different than the first gain, a second transmit power associated with the carrier 490 different than the first transmit power, a second SCS associated with the carrier 490 different than the first SCS, a second static PRACH configuration associated with the carrier 490 different than the first PRACH configuration, a second static TDD pattern associated with the carrier 490 different than the first static TDD pattern, a second static SRS configuration associated with the carrier 490 different than the first static SRS configuration, or a second endpoint configuration associated with the carrier 490 different than the first endpoint configuration. Other examples (such as different examples of parameters of the carrier 490) are also within the scope of the disclosure.

In some implementations, the DU 330 may indicate the trigger event 402 to the RU 340. Upon detecting the trigger event 402, the RU 340 may implement one or more stored configuration commands associated with the batch number 426. For example, the DU 330 may provide an instruction 430 to the RU 340 indicating the trigger event 402 and further indicating the batch number 426. In some examples, the instruction 430 indicates a particular point in time associated with the trigger event 402.

To illustrate, in some examples, the particular point in time may be indicated (or represented) using a particular frame number 432 associated with the particular point in time. The trigger event 402 may correspond to a frame boundary between a first frame associated with the particular frame number 432 and a second frame preceding the first frame. The frames may be included in data transmitted by the RU 340 to the UE 115 (e.g., via the carrier 490). To illustrate, the particular frame number 432 may be referred to as x (where x indicates a positive integer). In such examples, a transition from frame x-1 to frame x may correspond to the trigger event 402, and the RU 340 may detect the trigger event 402 based on identifying the transition from frame x-1 to frame x. As a result, the batch number 426 enables the RU 340 to “defer” implementation of stored configuration commands associated with the batch number 426 (such as the configuration commands 422 and 424) until detecting the trigger event 402, which may be associated with a particular point in time indicated by the instruction 430.

Alternatively or in addition, the particular point in time may be indicated (or represented) using one or more other parameters. For example, in another implementation, the particular point in time indicated by the instruction 430 may be associated with one or more of a global navigation satellite system (GNSS) time, a sub-frame number, a slot number, a symbol number, or another parameter. In the above examples, the batch number 426 enables the RU 340 to “defer” implementation of stored configuration commands associated with the batch number 426 (such as the configuration commands 422 and 424) until detecting the trigger event 402, which may be associated with a particular point in time indicated by the instruction 430.

Based on detecting the trigger event 402 the RU 340 may access one or more stored configuration commands associated with the batch number 426, such as by performing a search of the memory 242 (or another storage location) for one or more configuration commands having the batch number 426. For example, the RU 340 may access the configuration commands 422, 424 from the memory 242 based on a determination that the configuration commands 422, 424 are associated with the batch number 426. Based on detecting the trigger event 402, the RU 340 may perform the reconfiguration 406 of the carrier 490 from the first configuration 404 to the second configuration 408, such as by adjusting one or more of a gain associated with the carrier 490, a power associated with the carrier 490, an SCS associated with the carrier 490, or one or more other parameters associated with the carrier 490.

In some examples, the RU 340 may perform the reconfiguration 406 based on a particular order. The particular order may correspond to an order in which multiple configuration commands associated with the batch number 426 are received by the RU 340. To illustrate, in an example, the RU 340 may receive the configuration command 422 prior to receiving the configuration command 424. In this examples, performing the reconfiguration 406 based on the particular order may include implementing (e.g., executing) the configuration command 422 prior to implementing (e.g., executing) the configuration command 424.

In some examples, the RU 340 may transmit to the DU 330 (e.g., via the fronthaul link 480) a reporting message 440 indicating a status 442 associated with the reconfiguration 406 of the carrier 490. To illustrate, after performing the reconfiguration 406, the RU 340 may set the status 442 to indicate success of the reconfiguration 406.

In some examples, the reporting message 440 may also indicate one or more batch numbers. For example, the one or more batch numbers may include the batch number 426. Alternatively or in addition, the reporting message 440 may indicate multiple batch numbers. To illustrate, the reporting message 440 may indicate multiple statuses associated with multiple batch numbers (which may include the status 442 associated with the batch number 426).

In some circumstances, the reconfiguration 406 may fail. In such examples, the RU 340 may avoid changing the carrier 490 from the first configuration 404 to the second configuration 408, and the status 442 may indicate failure of the reconfiguration 406. To illustrate, in some implementations, the reconfiguration 406 is associated with a threshold time interval, and if the reconfiguration 406 is not initiated or completed within the threshold time interval, the reconfiguration 406 may fail (e.g., by “timing out”). To illustrate, the instruction 430 may specify or may be associated with a beginning of the threshold time interval. If the RU 340 does not detect the trigger event 402 within the threshold time interval (e.g., by detecting a transition to the particular frame number 432), the RU 340 may determine failure of the reconfiguration 406. In such examples, the RU 340 may set the status 442 to indicate failure of the reconfiguration 406. In some implementations, timing out of the reconfiguration 406 based on expiration of the threshold time interval may prevent late execution of the reconfiguration 406, which may otherwise occur in some circumstances (such as if frame numbers “wrap around” and are subsequently reused).

In some implementations, the status 442 includes a flag. The flag may have one of a first value (such as zero or one) to indicate success of the reconfiguration 406 or a second value (such as one or zero) to indicate failure of the reconfiguration 406. The RU 340 may select among the first value and the second value to indicate success of the reconfiguration 406 or failure of the reconfiguration 406, respectively, to the DU 330.

In some examples, if the status 442 indicates failure of the reconfiguration 406, the DU 330 may reinitiate the reconfiguration 406. For example, the DU 330 may provide a command to the RU 340 indicating that the RU 340 is to retry the reconfiguration 406 (or another reconfiguration).

In some implementations, the reconfiguration 406 may be associated with a guard time 412. For example, the guard time 412 may be associated with a particular mode (such as a reference state or a predetermined state) of the RU 340. In some examples, the particular mode corresponds to a mode in which the RU 340 temporarily terminates signal transmission, temporarily terminates signal reception, or both. In such examples, the guard time 412 may be associated with a particular mode in which one or more of signal transmission or signal reception are temporarily terminated. To illustrate, prior to initiating the reconfiguration 406, the RU 340 may initiate the particular mode. After initiating the particular mode, the RU 340 may initiate the reconfiguration 406. After completing the reconfiguration 406, the RU 340 discontinue the particular mode, such as by resuming transmission of signals, resuming reception of signals, or both. By performing the reconfiguration 406 while in the particular mode, the RU 340 may reduce or avoid instances of spurious signal transmission or reception, which may result from the RU 340 operating according to an unknown or “intermediate” configuration prior to completion of the reconfiguration 406.

In some examples, the guard time 412 may be based on a capability of the RU 340. To illustrate, the capability may include one or more of a quantity of processors of the RU 340, a processing speed of the RU 340, a load associated with the RU 340, one or more other parameters, or a combination thereof. Further, the RU 340 may transmit a capability message 410 to the DU 330 indicating the guard time 412. In such examples, the DU 330 may determine that the second configuration 408 is to take effect after the guard time 412.

In some examples, the guard time may be based on the specific one or more stored reconfiguration commands to be activated by based on the trigger event 402. To illustrate, some reconfiguration commands may take little or no time for reconfiguration such as a change to the static time division duplex (TDD) pattern, while other reconfiguration commands could take more time for reconfiguration such as a transmission power change. In such cases, the RU 340 may transmit a reporting message 440 to the DU 330 indicating the accumulated guard time for a set of stored commands as a status 442. In such examples, the DU 330 may determine that the second configuration 408 is to take effect after the guard time as conveyed in reporting message 440.

In some examples, the guard time 412 may occur prior the trigger event 402. In such examples, the RU 340 may initiate the particular mode and may perform the reconfiguration 406 prior to the trigger event 402, such as prior to a frame boundary associated with the particular frame number 432 (e.g., a frame boundary separating the xth frame from the (x-1)th frame). In some other examples, the guard time 412 may occur after the trigger event 402. In such examples, the RU 340 may initiate the particular mode and may perform the reconfiguration 406 after the trigger event 402, such as after a frame boundary associated with the particular frame number 432 (e.g., a frame boundary separating the xth frame from the (x-1)th frame).

In some examples, the RU 340 may transmit, to the DU 330, an acknowledgement (ACK) associated with each configuration command received from the DU 330. For example, the RU 340 may transmit, to the DU 330, a first ACK based on receiving the configuration command 422 and a second ACK based on receiving the configuration command 424. In some examples, each such ACK may indicate the batch number 426. In some examples, the DU 330 may transmit the instruction 430 based on a quantity of received ACKs from the RU 340 associated with the batch number 426. For example, if the reconfiguration 406 is to include implementing two configuration commands (such as the configuration commands 422, 424), then the DU 330 may send the instruction 430 to the RU 340 based on receiving two ACKS (which may indicate the batch number 426).

After performing the reconfiguration 406, the RU 340 may communicate with one or more UEs based on the second configuration 408 of the carrier 490. For example, the RU 340 may transmit data to or receive data from the UE 115 based on the second configuration 408 of the carrier 490.

In some examples, the RU 340 and the DU 330 may be referred to as network entities associated with an open radio access network (O-RAN), such as where the RU 340 corresponds to a first network entity of the O-RAN, and where the DU 330 corresponds to a second network entity of the O-RAN. The configuration commands 422 and 424 may be associated with a management plane (M-plane) that is associated with the O-RAN. In some examples, the configuration commands 422 and 424 may correspond to remote procedure call (RPC) commands received from the DU 330. In some aspects of the disclosure, the M-plane may be referred to as a semi-static M-plane (e.g., where batch processing of commands using batch numbers, such as the batch number 426, enables a semi-static state of the M-plane).

In some implementations, a network entity (such as the DU 330, the CU 310 of FIG. 3, the non-RT RIC 315 of FIG. 3, or another network entity) may issue one or more configuration commands (such as the configuration commands 422 and 424) to initiate the reconfiguration 406 based on one or more criteria. For example, the one or more criteria may include one or more of a time of day, a day of week, an operating state of the wireless communication system 400, or a load associated with the RU 340, as illustrative examples. To illustrate, in some implementations, a transmit power of the RU 340 or the UE 115 may be temporarily reduced via the reconfiguration 406 based on a time of day (e.g., at night), when fewer UEs may communicate with the RU 340 and less interference may be present within the wireless communication system 400.

Alternatively or in addition, the reconfiguration 406 may coordinated among multiple RUs, such as RUs of cells that are adjacent to a cell of the RU 340. In such examples, the trigger event 402 may be used across multiple RUs to improve performance or to reduce or avoid a conflict between the multiple RUs. To illustrate, in an example, an RU of an adjacent cell may be deactivated (e.g., based on a time of day, based on a quantity of UEs connected to the RU failing to exceed a threshold, or based on one or more other criteria), and a transmit power of the RU 340 or the UE 115 may be increased via the reconfiguration 406 while the RU of the adjacent cell is in a deactivated state. In such examples, the transmit power may be increased while the RU of the adjacent cell is less susceptible to interference from the UE 115 (e.g., while in the deactivated state). In another example, the RU 340 may be deactivated, and a transmit power associated with the adjacent cell may be increased.

Although a single batch number 426 has been described for illustration, in some examples, the wireless communication system 400 may use multiple batch numbers. For example, the RU 340 may receive multiple configuration commands associated with multiple different batch numbers. Each batch number may be associated with a different respective trigger event. Each batch number may be associated with a different respective carrier or with a different respective configuration of the carrier 490.

One or more features described herein may improve performance of a wireless communication system. For example, by using the batch number 426, the RU 340 may implement the configuration commands 422 and 424 at a common time or within a common time interval. As a result, the RU 340 may avoid or reduce instances of an unknown or intermediate configuration of the carrier 490 (which may occur if the configuration commands 422 and 424 arrive at or are executed by the RU 340 out-of-order). Further, in some examples, the RU 340 may perform the reconfiguration 406 of the carrier 490 on-the-fly and without temporarily disabling the carrier 490 during the reconfiguration 406. The RU 340 may also perform the reconfiguration 406 of the carrier 490 without reassigning the carrier 490 to another RU during the reconfiguration 406. As a result, availability of wireless resources is increased while also reducing or avoiding overhead associated with scheduling reassignment of the carrier 490, enhancing performance of the wireless communication system 400.

FIG. 5 is a flow diagram illustrating an example method 500 that supports batch numbering of one or more configuration commands for an RU according to one or more aspects. In some examples, the method 500 is performed by a network entity, such as the RU 340.

The method 500 includes receiving one or more configuration commands associated with a carrier having a first configuration, at 504. The one or more configuration commands each indicate a batch number. For example, the RU 340 may receive one or more of the configuration commands 422 and 424 from the DU 330 via the fronthaul link 480. The one or more configuration commands may indicate the batch number 426.

The method 500 further includes storing the one or more configuration commands, at 506. For example, the RU 340 may store (e.g., cache or buffer) one or more of the configuration commands 422 and 424 at the memory 242 or at another location, such as at a cache or a buffer.

The method 500 further includes, based on detecting a trigger event, performing a reconfiguration of the carrier from the first configuration to a second configuration that is based on the one or more configuration commands, at 508. For example, based on detecting the trigger event 402, the RU 340 may perform the reconfiguration 406 of the carrier 490 from the first configuration 404 to the second configuration 408.

FIG. 6 is a flow diagram illustrating an example method 600 that supports batch numbering of one or more configuration commands for an RU according to one or more aspects. In some examples, the method 600 is performed by a network entity, such as the DU 330.

The method 600 includes transmitting one or more configuration commands associated with a carrier, at 602. The one or more configuration commands each indicate a batch number. For example, the DU 330 may transmit one or more of the configuration commands 422 and 424 to the RU 340 via the fronthaul link 480. The one or more configuration commands may indicate the batch number 426.

The method 600 further includes receiving a reporting message indicating a status associated with reconfiguration of the carrier from a first configuration to a second configuration based on the one or more configuration commands, at 604. For example, the DU 330 may receive the reporting message 440 from the RU 340 (e.g., via the fronthaul link 480) indicating the status 442 associated with the reconfiguration 406 of the carrier 490 from the first configuration 404 to the second configuration 408.

In a first aspect, an apparatus for wireless communication by a network entity includes a memory and one or more processors coupled to the memory. The one or more processors are configured to receive one or more configuration commands associated with a carrier having a first configuration. The one or more configuration commands each indicate a batch number. The one or more processors are further configured to store the one or more configuration commands and, based on detection of a trigger event, to perform a reconfiguration of the carrier from the first configuration to a second configuration that is based on the one or more configuration commands.

In a second aspect, in combination with the first aspect, the one or more processors are further configured to receive, prior to detecting the trigger event, an instruction indicating the trigger event and further indicating the batch number.

In a third aspect, in combination with one or more of the first aspect or the second aspect, the instruction indicates a particular point in time associated with the trigger event, and the particular point in time is associated with one or more of a global navigation satellite system (GNSS) time, a frame number, a sub-frame number, a slot number, a symbol number, or another parameter.

In a fourth aspect, in combination with one or more of the first aspect through the third aspect, the one or more configuration commands include multiple configuration commands associated with the batch number, the one or more processors are further configured to receive the multiple configuration commands in a particular order, and the one or more processors are further configured to perform the reconfiguration based on the particular order.

In a fifth aspect, in combination with one or more of the first aspect through the fourth aspect, the one or more processors are further configured to transmit a capability message indicating a guard time associated with the reconfiguration of the carrier from the first configuration to the second configuration.

In a sixth aspect, in combination with one or more of the first aspect through the fifth aspect, the guard time occurs prior to the trigger event or after the trigger event, and the guard time is associated with a particular mode in which one or more of signal transmission or signal reception are temporarily terminated.

In a seventh aspect, in combination with one or more of the first aspect through the sixth aspect, the one or more processors are further configured to transmit a reporting message indicating a guard time associated with the reconfiguration of the carrier from the first configuration to the second configuration based on all configuration messages associated with the batch number so far.

In an eighth aspect, in combination with one or more of the first aspect through the seventh aspect, the one or more processors are further configured to transmit a reporting message indicating a status associated with the reconfiguration of the carrier.

In a ninth aspect, in combination with one or more of the first aspect through the eighth aspect, the reporting message further indicates one or more batch numbers including the batch number.

In a tenth aspect, in combination with one or more of the first aspect through the ninth aspect, the network entity corresponds to a radio unit (RU) associated with an open radio access network (O-RAN), the one or more configuration commands are associated with a management plane (M-plane) that is associated with the O-RAN, and the one or more configuration commands correspond to remote procedure call (RPC) commands received from a distributed unit (DU) associated with the O-RAN.

In an eleventh aspect, in combination with one or more of the first aspect through the tenth aspect, the one or more configuration commands indicate one or more of a gain change associated with the carrier, a transmit power change associated with the carrier, a subcarrier spacing (SCS) change associated with the carrier, a static physical random access channel (PRACH) configuration change associated with the carrier, a static time division duplex (TDD) pattern change associated with the carrier, a static sounding reference signal (SRS) configuration change associated with the carrier, an endpoint configuration change associated with the carrier, or another configuration change associated with the carrier.

In a twelfth aspect, a method of wireless communication performed by a network entity includes receiving one or more configuration commands associated with a carrier having a first configuration. The one or more configuration commands each indicate a batch number. The method further includes storing the one or more configuration commands and further includes, based on detecting a trigger event, performing a reconfiguration of the carrier from the first configuration to a second configuration that is based on the one or more configuration commands.

In a thirteenth aspect, in combination with the twelfth aspect, the method further includes, prior to detecting the trigger event, receiving an instruction indicating the trigger event and further indicating the batch number.

In a fourteenth aspect, in combination with one or more of the twelfth aspect through the thirteenth aspect, the instruction indicates a particular point in time associated with the trigger event, and the particular point in time is associated with one or more of a global navigation satellite system (GNSS) time, a frame number, a sub-frame number, a slot number, a symbol number, or another parameter.

In a fifteenth aspect, in combination with one or more of the twelfth aspect through the fourteenth aspect, the one or more configuration commands include multiple configuration commands associated with the batch number received in a particular order, and the reconfiguration is performed based on the particular order.

In a sixteenth aspect, in combination with one or more of the twelfth aspect through the fifteenth aspect, the method further includes transmitting a capability message indicating a guard time associated with the reconfiguration of the carrier from the first configuration to the second configuration.

In a seventeenth aspect, in combination with one or more of the twelfth aspect through the sixteenth aspect, the guard time occurs prior to the trigger event or after the trigger event, and the guard time is associated with a particular mode in which one or more of signal transmission or signal reception are temporarily terminated.

In an eighteenth aspect, in combination with one or more of the twelfth aspect through the seventeenth aspect, the method further includes transmitting a reporting message indicating a guard time associated with the reconfiguration of the carrier from the first configuration to the second configuration based on all configuration messages associated with the batch number so far.

In a nineteenth aspect, in combination with one or more of the twelfth aspect through the eighteenth aspect, the method further includes transmitting a reporting message indicating a status associated with the reconfiguration of the carrier.

In a twentieth aspect, in combination with one or more of the twelfth aspect through the nineteenth aspect, the reporting message further indicates one or more batch numbers including the batch number.

In a twenty-first aspect, in combination with one or more of the twelfth aspect through the twentieth aspect, the network entity corresponds to a radio unit (RU) associated with an open radio access network (O-RAN), the one or more configuration commands are associated with a management plane (M-plane) that is associated with the O-RAN, and the one or more configuration commands correspond to remote procedure call (RPC) commands received from a distributed unit (DU) associated with the O-RAN.

In a twenty-second aspect, in combination with one or more of the twelfth aspect through the twenty-first aspect, the one or more configuration commands indicate one or more of a gain change associated with the carrier, a transmit power change associated with the carrier, a subcarrier spacing (SCS) change associated with the carrier, a static physical random access channel (PRACH) configuration change associated with the carrier, a static time division duplex (TDD) pattern change associated with the carrier, a static sounding reference signal (SRS) configuration change associated with the carrier, an endpoint configuration change associated with the carrier, or another configuration change associated with the carrier.

In a twenty-third aspect, an apparatus for wireless communication by a network entity includes a memory and one or more processors coupled to the memory. The one or more processors are configured to transmit one or more configuration commands associated with a carrier. The one or more configuration commands each indicate a batch number. The one or more processors are further configured to receive a reporting message indicating a status associated with reconfiguration of the carrier from a first configuration to a second configuration based on the one or more configuration commands.

In a twenty-fourth aspect, in combination with the twenty-third aspect, the one or more processors are further configured to transmit, prior to receiving the reporting message, an instruction indicating a trigger event associated with the reconfiguration of the carrier and further indicating the batch number.

In a twenty-fifth aspect, in combination with one or more of the twenty-third aspect through the twenty-fourth aspect, the instruction indicates a particular point in time associated with the trigger event, and the particular point in time is associated with one or more of a global navigation satellite system (GNSS) time, a frame number, a sub-frame number, a slot number, a symbol number, or another parameter.

In a twenty-sixth aspect, in combination with one or more of the twenty-third aspect through the twenty-fifth aspect, the one or more configuration commands include multiple configuration commands associated with the batch number that are transmitted in a particular order, and the reconfiguration is performed based on the particular order

In a twenty-seventh aspect, in combination with one or more of the twenty-third aspect through the twenty-sixth aspect, the one or more processors are further configured to receive a capability message indicating a guard time associated with the reconfiguration of the carrier from the first configuration to the second configuration.

In a twenty-eighth aspect, in combination with one or more of the twenty-third aspect through the twenty-seventh aspect, the guard time occurs prior to a trigger event associated with the reconfiguration or after the trigger event associated with the reconfiguration, and the guard time is associated with a particular mode in which one or more of signal transmission or signal reception are temporarily terminated.

In a twenty-ninth aspect, in combination with one or more of the twenty-third aspect through the twenty-eighth aspect, the reporting message indicates a guard time associated with the reconfiguration of the carrier from the first configuration to the second configuration based on all configuration messages associated with the batch number so far.

In a thirtieth aspect, in combination with one or more of the twenty-third aspect through the twenty-ninth aspect, the reporting message further indicates one or more batch numbers including the batch number.

In a thirty-first aspect, in combination with one or more of the twenty-third aspect through the thirtieth aspect, the network entity corresponds to a distributed unit (DU) associated with an open radio access network (O-RAN), the one or more configuration commands are associated with a management plane (M-plane) that is associated with the O-RAN, and the one or more configuration commands correspond to remote procedure call (RPC) commands transmitted to a radio unit (RU) associated with the O-RAN.

In a thirty-second aspect, in combination with one or more of the twenty-third aspect through the thirty-first aspect, the one or more configuration commands indicate one or more of a gain change associated with the carrier, a transmit power change associated with the carrier, a subcarrier spacing (SCS) change associated with the carrier, a static physical random access channel (PRACH) configuration change associated with the carrier, a static time division duplex (TDD) pattern change associated with the carrier, a static sounding reference signal (SRS) configuration change associated with the carrier, an endpoint configuration change associated with the carrier, or another configuration change associated with the carrier.

In a thirty-third aspect, a method of wireless communication by a network entity includes transmitting one or more configuration commands associated with a carrier. The one or more configuration commands each indicate a batch number. The method further includes receiving a reporting message indicating a status associated with reconfiguration of the carrier from a first configuration to a second configuration based on the one or more configuration commands.

In a thirty-fourth aspect, in combination with the thirty-fourth aspect, the method further includes transmitting, prior to receiving the reporting message, an instruction indicating a trigger event associated with the reconfiguration of the carrier and further indicating the batch number.

In a thirty-fifth aspect, in combination with one or more of the thirty-third aspect through the thirty-third aspect, the instruction indicates a particular point in time associated with the trigger event, and the particular point in time is associated with one or more of a global navigation satellite system (GNSS) time, a frame number, a sub-frame number, a slot number, a symbol number, or another parameter.

In a thirty-sixth aspect, in combination with one or more of the thirty-third aspect through the thirty-fifth aspect, the one or more configuration commands include multiple configuration commands associated with the batch number transmitted in a particular order, and the reconfiguration is performed based on the particular order.

In a thirty-seventh aspect, in combination with one or more of the thirty-third aspect through the thirty-sixth aspect, the method further includes receiving a capability message indicating a guard time associated with the reconfiguration of the carrier from the first configuration to the second configuration.

In a thirty-eighth aspect, in combination with one or more of the thirty-third aspect through the thirty-seventh aspect, the guard time occurs prior to a trigger event associated with the reconfiguration or after the trigger event associated with the reconfiguration, and the guard time is associated with a particular mode in which one or more of signal transmission or signal reception are temporarily terminated.

In a thirty-ninth aspect, in combination with one or more of the thirty-third aspect through the thirty-eighth aspect, the reporting message indicates a guard time associated with the reconfiguration of the carrier from the first configuration to the second configuration based on all configuration messages associated with the batch number so far.

In a fortieth aspect, in combination with one or more of the thirty-third aspect through the thirty-ninth aspect, the reporting message further indicates one or more batch numbers including the batch number.

In a forty-first aspect, in combination with one or more of the thirty-third aspect through the fortieth aspect, the network entity corresponds to a distributed unit (DU) associated with an open radio access network (O-RAN), the one or more configuration commands are associated with a management plane (M-plane) that is associated with the O-RAN, and the one or more configuration commands correspond to remote procedure call (RPC) commands transmitted to a radio unit (RU) associated with the O-RAN.

In a forty-second aspect, in combination with one or more of the thirty-third aspect through the forty-first aspect, the one or more configuration commands indicate one or more of a gain change associated with the carrier, a transmit power change associated with the carrier, a subcarrier spacing (SCS) change associated with the carrier, a static physical random access channel (PRACH) configuration change associated with the carrier, a static time division duplex (TDD) pattern change associated with the carrier, a static sounding reference signal (SRS) configuration change associated with the carrier, an endpoint configuration change associated with the carrier, or another configuration change associated with the carrier.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features described herein may be implemented via specialized processor circuitry, via executable instructions, or combinations thereof.

One or more illustrative logics, logical blocks, modules, circuits, and processes described herein may be implemented as electronic hardware, computer software, or combinations of both. Whether such functionality may be implemented in hardware or software may depend upon the particular application and design of the overall system.

A hardware and data processing apparatus used to implement one or more illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

One or more functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, a data processing apparatus.

If implemented in software, one or more such functions may be stored on or transmitted over as one or more instructions or code on a computer-readable medium. One or more operations of a method or process disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or process may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication by a network entity, the apparatus comprising:
a memory; and
one or more processors coupled to the memory and configured to:
receive one or more configuration commands associated with a carrier having a first configuration, the one or more configuration commands each indicating a batch number;
store the one or more configuration commands; and
based on detection of a trigger event, perform a reconfiguration of the carrier from the first configuration to a second configuration that is based on the one or more configuration commands.

2. The apparatus of claim 1, wherein the one or more processors are further configured to receive, prior to detecting the trigger event, an instruction indicating the trigger event and further indicating the batch number.

3. The apparatus of claim 2, wherein the instruction indicates a particular point in time associated with the trigger event, and wherein the particular point in time is associated with one or more of a global navigation satellite system (GNSS) time, a frame number, a sub-frame number, a slot number, a symbol number, or another parameter.

4. The apparatus of claim 1, wherein the one or more configuration commands include multiple configuration commands associated with the batch number, wherein the one or more processors are further configured to receive the multiple configuration commands in a particular order, and wherein the one or more processors are further configured to perform the reconfiguration based on the particular order.

5. The apparatus of claim 1, wherein the one or more processors are further configured to transmit a capability message indicating a guard time associated with the reconfiguration of the carrier from the first configuration to the second configuration.

6. The apparatus of claim 5, wherein the guard time occurs prior to the trigger event or after the trigger event, and wherein the guard time is associated with a particular mode in which one or more of signal transmission or signal reception are temporarily terminated.

7. The apparatus of claim 1, wherein the one or more processors are further configured to transmit a reporting message indicating a guard time associated with the reconfiguration of the carrier from the first configuration to the second configuration based on all configuration messages associated with the batch number so far.

8. The apparatus of claim 1, wherein the one or more processors are further configured to transmit a reporting message indicating a status associated with the reconfiguration of the carrier.

9. A method of wireless communication performed by a network entity, the method comprising:
receiving one or more configuration commands associated with a carrier having a first configuration, the one or more configuration commands each indicating a batch number;
storing the one or more configuration commands; and
based on detecting a trigger event, performing a reconfiguration of the carrier from the first configuration to a second configuration that is based on the one or more configuration commands.

10. The method of claim 9, further comprising, prior to detecting the trigger event, receiving an instruction indicating the trigger event and further indicating the batch number.

11. The method of claim 10, wherein the instruction indicates a particular point in time associated with the trigger event, and wherein the particular point in time is associated with one or more of a global navigation satellite system (GNSS) time, a frame number, a sub-frame number, a slot number, a symbol number, or another parameter.

12. The method of claim 9, wherein the one or more configuration commands include multiple configuration commands associated with the batch number received in a particular order, and wherein the reconfiguration includes is performed based on the particular order.

13. The method of claim 9, further comprising transmitting a capability message indicating a guard time associated with the reconfiguration of the carrier from the first configuration to the second configuration.

14. The method of claim 13, wherein the guard time occurs prior to the trigger event or after the trigger event.

15. The method of claim 9, further comprising transmitting a reporting message indicating a guard time associated with the reconfiguration of the carrier from the first configuration to the second configuration based on all configuration messages associated with the batch number so far.

16. The method of claim 9, further comprising transmitting a reporting message indicating a status associated with the reconfiguration of the carrier.

17. An apparatus for wireless communication by a network entity, the apparatus comprising:
a memory; and
one or more processors coupled to the memory and configured to:
transmit one or more configuration commands associated with a carrier, the one or more configuration commands each indicating a batch number; and
receive a reporting message indicating a status associated with reconfiguration of the carrier from a first configuration to a second configuration based on the one or more configuration commands.

18. The apparatus of claim 17, wherein the one or more processors are further configured to transmit, prior to receiving the reporting message, an instruction indicating a trigger event associated with the reconfiguration of the carrier and further indicating the batch number.

19. The apparatus of claim 18, wherein the instruction indicates a particular point in time associated with the trigger event, and wherein the particular point in time is associated with one or more of a global navigation satellite system (GNSS) time, a frame number, a sub-frame number, a slot number, a symbol number, or another parameter.

20. The apparatus of claim 17, wherein the one or more configuration commands include multiple configuration commands associated with the batch number that are transmitted in a particular order, and wherein the reconfiguration is performed based on the particular order.

21. The apparatus of claim 17, wherein the one or more processors are further configured to receive a capability message indicating a guard time associated with the reconfiguration of the carrier from the first configuration to the second configuration.

22. The apparatus of claim 21, wherein the guard time occurs prior to a trigger event associated with the reconfiguration or after the trigger event associated with the reconfiguration.

23. The apparatus of claim 17, wherein the reporting message indicates a guard time associated with the reconfiguration of the carrier from the first configuration to the second configuration based on all configuration messages associated with the batch number so far.

24. A method for wireless communication by a network entity, the method comprising:
transmitting one or more configuration commands associated with a carrier, the one or more configuration commands each indicating a batch number; and
receiving a reporting message indicating a status associated with reconfiguration of the carrier from a first configuration to a second configuration based on the one or more configuration commands.

25. The method of claim 24, further comprising transmitting, prior to receiving the reporting message, an instruction indicating a trigger event associated with the reconfiguration of the carrier and further indicating the batch number.

26. The method of claim 25, wherein the instruction indicates a particular point in time associated with the trigger event, and wherein the particular point in time is associated with one or more of a global navigation satellite system (GNSS) time, a frame number, a sub-frame number, a slot number, a symbol number, or another parameter.

27. The method of claim 24, wherein the one or more configuration commands include multiple configuration commands associated with the batch number that are transmitted in a particular order, and wherein the reconfiguration is performed based on the particular order.

28. The method of claim 24, further comprising receiving a capability message indicating a guard time associated with the reconfiguration of the carrier from the first configuration to the second configuration.

29. The method of claim 28, wherein the guard time occurs prior to a trigger event associated with the reconfiguration or after the trigger event associated with the reconfiguration.

30. The method of claim 24, wherein the reporting message indicates a guard time associated with the reconfiguration of the carrier from the first configuration to the second configuration based on all configuration messages associated with the batch number so far.
